(19) United States
(12) Patent Application Publication
(10) Pub. No.: US 2026/0069497 A1
(43) Pub. Date: Mar. 12, 2026

(54) TELESCOPIC AND ROTATABLE MASSAGER

(71) Applicant: Dongguan Duoguo Zhichuang Technology Co., Ltd., Dongguan City (CN)

(72) Inventor: Changzhi Luo, Dongguan City (CN)

(21) Appl. No.: 19/393,157

(22) Filed: Nov. 18, 2025

(30) Foreign Application Priority Data
Oct. 13, 2025 (CN) 202522162182.9

(51) Int. Cl. A61H 23/02; A61H 7/00

(52) U.S. Cl. CPC A61H 23/0254; A61H 7/004; A61H 2201/0192; A61H 2201/1215; A61H 2201/14; A61H 2201/1669; A61H 2201/1671

(57) ABSTRACT

A telescopic and rotatable massager includes a gripping portion, a massage stick, a telescopic power device and a rotating power device. The massage stick is provided with an assembling portion at a first end and rotatably provided with a massage head at a second end. The telescopic power device is disposed in the gripping portion. The rotating power device is disposed in the massage stick. The massager realizes reciprocating telescoping of the massage stick and the gripping portion by the telescopic power device, and realizes rotation of the massage head by the rotating power device, thus achieving diversified massage functions and good massage effects.

### TECHNICAL FIELD

The present invention belongs to the field of massagers, and in particular relates to a telescopic and rotatable massager.

### BACKGROUND

Electric massagers work by driving massage heads to expand, and contract, vibrate and perform other actions through operation of power sources such as motors, thus massaging the parts that need to be massaged such as hands, legs, face, prostate, etc.

Existing electric massager has the problem of limited massage functions. For example, a driving device of an automatic telescopic massager disclosed in Chinese Patent No. CN201921411021.7 has a driving motor to cooperate with a worm gear and a worm, and the worm gear performs eccentric output to realize reciprocating telescoping of a telescopic cylinder, and the reciprocating telescopic cylinder achieves massage by rubbing against the massage area through a side wall thereof or by impacting the massage area with a head thereof.

How to increase the functionality of massagers to diversify massage functions and achieve better massage effects is an urgent problem for those skilled in the art.

### SUMMARY

In view of the deficiencies of the prior art, it is an object of the present invention to provide a telescopic and rotatable massager that realizes reciprocating telescoping of a massage stick and a gripping portion by a telescopic power device, and realizes rotation of a massage head by a rotating power device, thus achieving diversified massage functions and good massage effects.

In order to achieve the above object, the present invention provides the following technical solution.

A telescopic and rotatable massager includes: a gripping portion; a massage stick, where the massage stick is provided with an assembling portion in sliding fit with the gripping portion at a first end thereof, and the massage stick is slidably disposed relative to the gripping portion along a length direction thereof, the massage stick is rotatably provided with a massage head at a second end thereof, and a rotation axis of the massage head relative to the massage stick is parallel to a sliding direction of the massage stick; a telescopic power device provided in the gripping portion and operating to drive the massage stick to slide back and forth; and a rotating power device provided in the massage stick and used to drive the massage head to rotate relative to the massage stick.

The present invention is further provided as follows: the telescopic power device includes a first motor, a first worm, a linkage worm gear and a linkage swing rod, the first worm is connected with an output shaft of the first motor, the linkage worm gear is rotatably disposed relative to the gripping portion, the first worm is meshed with the linkage worm gear, and the linkage swing rod is rotatably disposed relative to the linkage worm gear and the assembling portion respectively; a rotation axis of the linkage worm gear relative to the gripping portion is k1, a rotation axis of the linkage swing rod relative to the linkage worm gear is k2, a rotation axis of the linkage swing rod relative to the assembling portion is k3, k1, k2 and k3 are disposed non-collinear and parallel, and k1 and the sliding direction of the massage stick are perpendicular to each other; and the telescopic power device further includes a second motor and a second worm, the second worm is connected with an output shaft of the second motor, and the second worm is meshed with the linkage worm gear.

By adopting the technical solution, a user can hold the gripping portion by hand. Firstly, the massage stick is driven by the telescopic power device to reciprocate and contract in the left-right direction. Secondly, the massage head is driven by a vibration power device to vibrate at high frequency. Thirdly, the massage head is driven by the rotating power device to rotate in a circumferential direction. Thus, massage can be achieved through friction between a side wall of the reciprocating telescopic massage stick and a massage area, impact of the reciprocating telescopic massage head on the massage area, vibration transmitted from the high-frequency vibrating massage head to the massage area, and friction between an outer wall of the rotating massage head and the massage area, resulting in diversified massage functions and better massage effects.

### BRIEF DESCRIPTION OF THE DRAWINGS

In order to illustrate the technical solutions of the embodiments of the present invention or the prior art more clearly, the accompanying drawings to be used in the description of the embodiments or the prior art will be briefly introduced below. Obviously, the accompanying drawings in the following description are merely some rather than all embodiments of the present invention, and a person of ordinary skill in the art may still derive other drawings from these accompanying drawings without creative efforts.

FIG. 1 is an assembly diagram of Embodiment 1 of the present invention;

FIG. 2 is a state diagram in which a protective sleeve is opened according to Embodiment 1;

FIG. 3 is a sectional view of Embodiment 1;

FIG. 4 is an exploded view of Embodiment 1;

FIG. 5 is an enlarged view of A in FIG. 3;

FIG. 6 is an enlarged view of a portion of FIG. 3;

FIG. 7 is an enlarged view of a portion of FIG. 3;

FIG. 8 is an exploded view of a gripping portion according to Embodiment 1;

FIG. 9 is an exploded view of a massage stick according to Embodiment 1;

FIG. 10 is an exploded view of a massage head according to Embodiment 1;

FIG. 11 is an assembly diagram of a telescopic power device according to Embodiment 1;

FIG. 12 is an assembly diagram of the telescopic power device according to Embodiment 1;

FIG. 13 is an assembly diagram of the telescopic power device according to Embodiment 1;

FIG. 14 is an assembly diagram of a first rotating power device according to Embodiment 1;

FIG. 15 is an exploded view of the first rotating power device according to Embodiment 1;

FIG. 16 is an exploded view of the first rotating power device according to Embodiment 1;

FIG. 17 is an assembly diagram of a second rotating power device according to Embodiment 1;

FIG. 18 is an exploded view of the second rotating power device according to Embodiment 1;

FIG. 19 is an exploded view of Embodiment 2 of the present invention;

FIG. 20 is a sectional view of Embodiment 2;

FIG. 21 is a partial structural assembly diagram of a massage stick according to Embodiment 2;

FIG. 22 is an assembly diagram of an assembling portion according to Embodiment 2;

FIG. 23 is an exploded view of a detachable structure according to Embodiment 2;

FIG. 24 is an exploded view of the detachable structure according to Embodiment 2;

FIG. 25 is an enlarged view of B in FIG. 20; and

FIG. 26 is an enlarged view of a portion of FIG. 20.

### DESCRIPTION OF REFERENCE NUMERALS

1. gripping portion;
11. outer housing; 12. inner housing; 13. first fixing bolt; 14. second fixing bolt; 15. guide sleeve; 17. corrugated sealing sleeve; 18. second clamping end cover; 19. elastic ring;
111. first cylinder portion; 112. second cylinder portion; 113. first inner cavity; 121. first housing portion; 122. second housing portion; 123. second inner cavity; 151. bar-shaped slot; 171. first clamping sealing portion; 172. second clamping sealing portion; 191. mounting portion; 192. impact deformation portion;
2. massage stick;
21. elastic sleeve; 22. detachable structure;
221. rotating slot; 222. rotating insertion portion;
2211. anti-detachment track; 2221. anti-detachment slider;
22111. first snap-in protrusion; 22112. first snap-in recess; 22113. insertion opening; 22211. second snap-in recess; 22212. second snap-in protrusion;
3. assembling portion;
31. mounting side portion; 32. bar-shaped snap-in protrusion; 33. first wiring channel; 34. first clamping end cover;
311. first wiring notch;
4. massage head;
5. telescopic power device;
51. first motor; 52. first worm; 53. second motor; 54. second worm; 55. linkage worm gear; 56. linkage swing rod;
6. vibration power device;
7. rotating power device;
71. third motor; 72. connector;
721. second wiring channel; 722. second wiring notch;
81. first electrical connection assembly; 82. second electrical connection assembly;
811. first component; 812. second component; 821. first circuit board; 822. second circuit board;
8111. first conduction ring; 8112. second conduction ring; 8113. third conduction ring; 8114. fourth conduction ring; 8121. first conduction portion; 8122. second conduction portion; 8129. conduction seat; 8123. third conduction portion; 8124. fourth conduction portion;
8211. first wiring socket; 8212. first electrical connection portion; 8221. second wiring socket; 8222. second electrical connection portion;
91. protective sleeve; and 92. battery.

### DESCRIPTION OF THE EMBODIMENTS

In order to make those skilled in the art better understand the present invention and thereby define the scope of the present invention more clearly, the present invention is described below in detail with respect to some specific embodiments of the present invention. It should be noted that the following description only relates to some specific embodiments of the inventive concept and are only part of the embodiments of the present invention, specific and direct descriptions of relevant structures are merely for the convenience of understanding the present invention, and the specific features do not, of course, directly limit the implementation scope of the present invention. Conventional choices and alternatives made by those skilled in the art under the guidance of the inventive concept should be considered within the scope of the present invention. Embodiment 1:

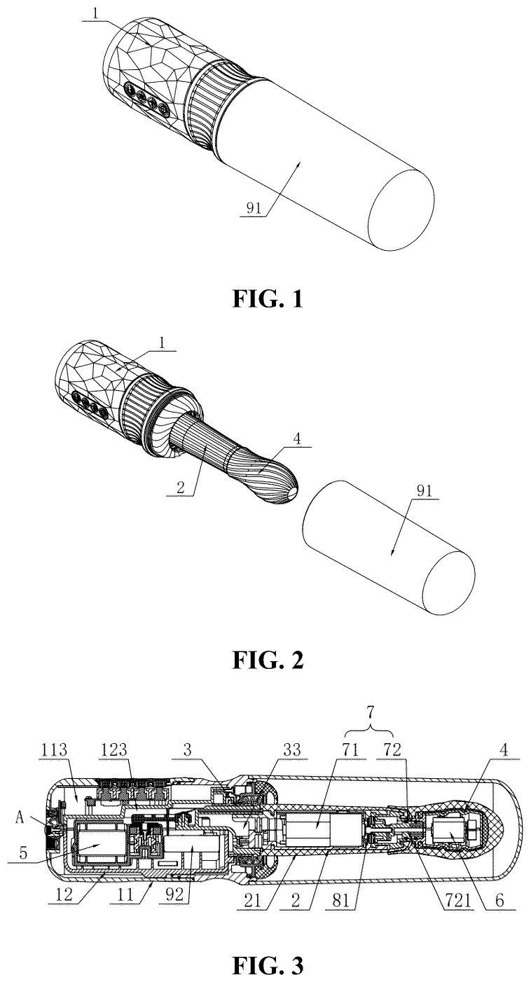

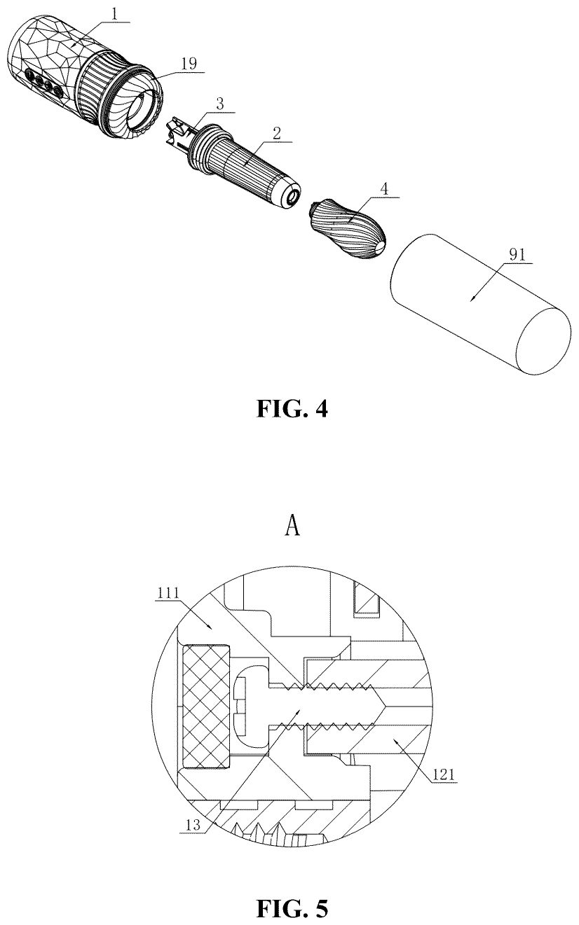

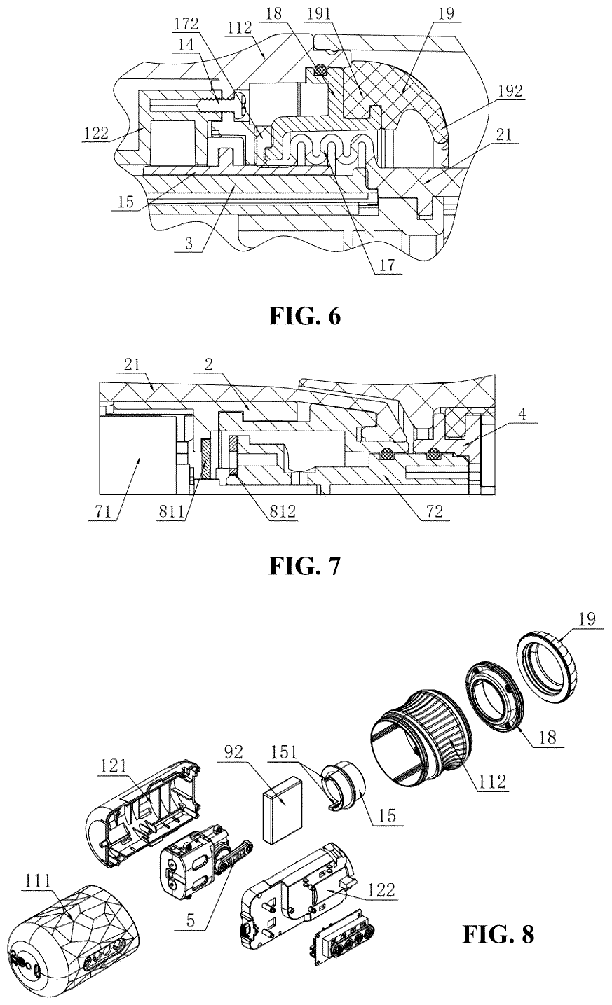

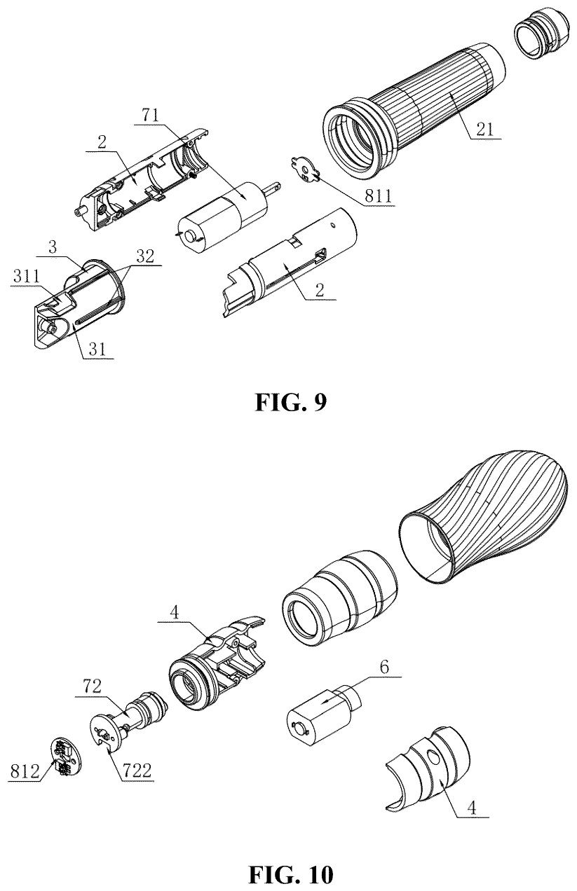

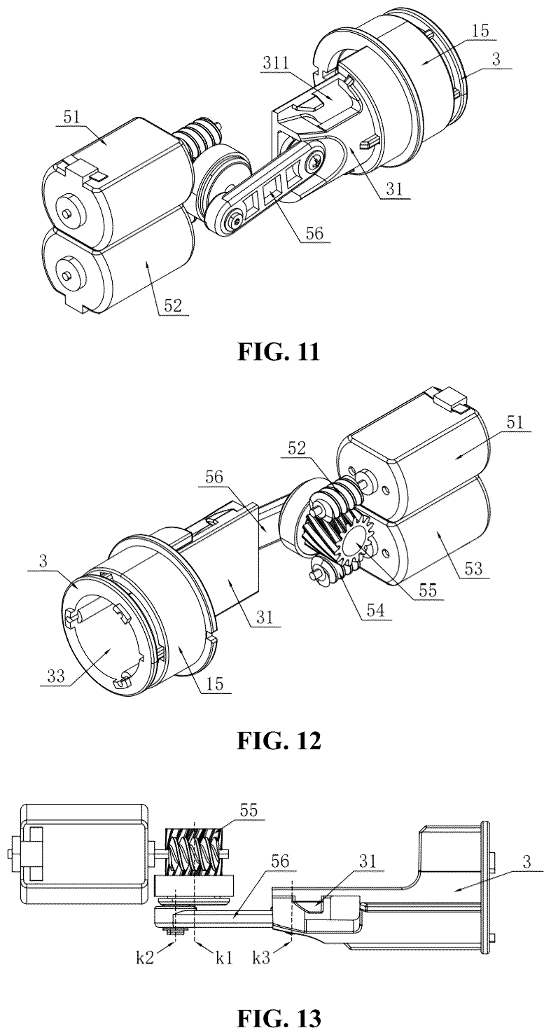

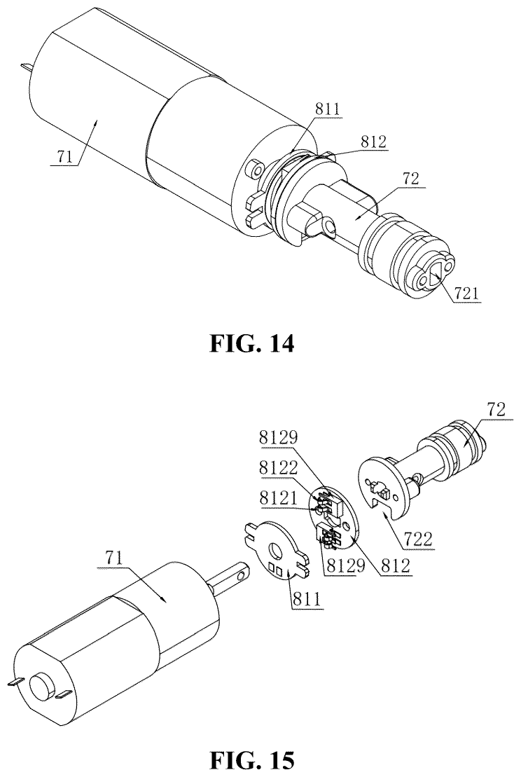

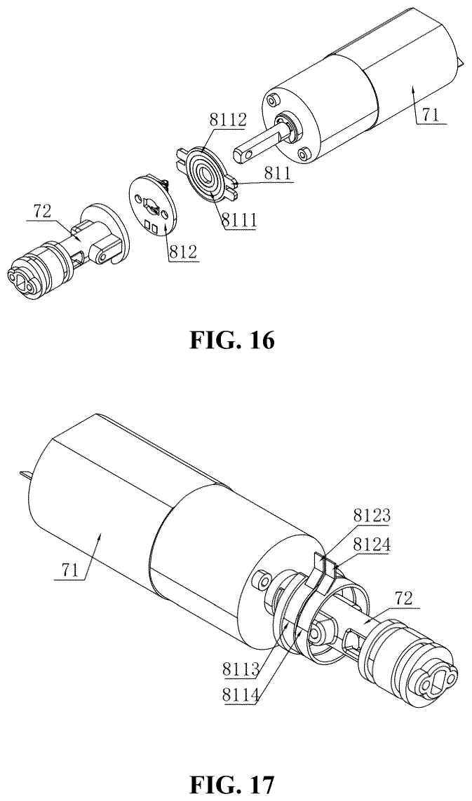

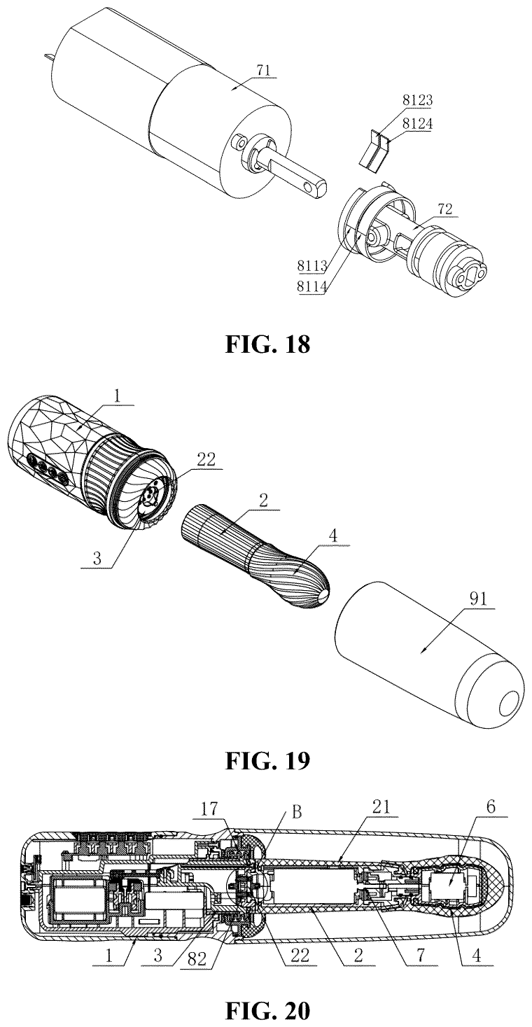

As shown in FIGS. 1-18, the present embodiment relates to a telescopic and rotatable massager including: a gripping portion 1, where the gripping portion 1 takes a quasi-cylindrical shape and has a length direction extending in the left-right direction; a massage stick 2, where the massage stick 2 is located at a right end of the gripping portion 1, a length direction of the massage stick 2 extends in the left-right direction, the massage stick 2 is provided with an assembling portion 3 at a left end thereof, the assembling portion 3 and the gripping portion 1 are in sliding fit in the left-right direction, and the massage stick 2 is provided with a massage head 4 at a right end thereof; a telescopic power device 5, where the telescopic power device 5 is disposed in the gripping portion 1, and the telescopic power device 5 operates to drive the massage stick 2 to slide back and forth; and a rotating power device 7, where the rotating power device 7 is disposed in the massage stick 2, and the rotating power device 7 is used to drive the massage head 4 to rotate relative to the massage stick 2. Preferably, a rotation axis of the massage head 4 relative to the massage stick 2 is parallel to the sliding direction of the massage stick 2.

Preferably, the telescopic and rotatable massager may further include a vibration power device 6, the vibration power device 6 is disposed in the massage head 4, and the vibration power device 6 operates to realize vibration of the massage head 4.

Therefore, a user can hold the gripping portion 1 by hand, the massage stick 2 is driven by the telescopic power device 5 to reciprocate and contract in the left-right direction, the massage head 4 is driven by the rotating power device 7 to rotate in a circumferential direction, and the massage head 4 is driven by the vibration power device 6 to vibrate at high frequency, thus massage can be achieved through friction between a side wall of the reciprocating telescopic massage stick 2 and a massage area, impact of the reciprocating telescopic massage head 4 on the massage area, friction between an outer wall of the rotating massage head 4 and the massage area, and vibration transmitted from the high-frequency vibrating massage head 4 to the massage area, resulting in diversified massage functions and better massage effects.

The telescopic and rotatable massager further includes a protective sleeve 91, the protective sleeve 91 may be sleeved on an outer periphery of the massage stick 2, and may be in snap connection or threaded connection with the gripping portion 1 for detachable mounting.

Specifically, the telescopic power device 5 includes a first motor 51, a first worm 52, a linkage worm gear 55 and a linkage swing rod 56; the first worm 52 is fixedly disposed on an output shaft of the first motor 51, the linkage worm gear 55 is rotatably disposed relative to the gripping portion 1, the first worm 52 and the linkage worm gear 55 are meshed with each other, and both ends of the linkage swing rod 56 are hinged to the linkage worm gear 55 and the assembling portion 3 respectively; and a rotation axis of the linkage worm gear 55 relative to the gripping portion 1 is k1, a rotation axis of the linkage swing rod 56 relative to the linkage worm gear 55 is k2, and a rotation axis of the linkage swing rod 56 relative to the assembling portion 3 is k3, directions of k1, k2, and k3 are all along the front-back direction, and k1, k2, and k3 are disposed in non-collinear and parallel.

Therefore, when the first motor 51 operates, the first worm 52 drives the linkage worm gear 55 to rotate, and drives the assembling portion 3 to reciprocate left and right under the linkage of the linkage swing rod 56, ultimately achieving telescopic motion of the massage stick 2.

In addition, the telescopic power device 5 further includes a second motor 53 and a second worm 54, the second worm 54 is connected with an output shaft of the second motor 53, and the second worm 54 is meshed with the linkage worm gear 55, thereby improving power strength under the joint action of the first motor 51 and the second motor 53.

Preferably, the first motor 51 and the second motor 53 are located on a left side of the linkage worm gear 55, the massage stick 2 is located on a right side of the linkage worm gear 55, the first worm 52 and the second worm 54 are located on upper and lower sides of the linkage worm gear 55 respectively, and an axial direction of the first worm 52 and an axial direction of the second worm 54 are both along the sliding direction of the massage stick 2.

Therefore, the first motor 51 and the second motor 53 are disposed in parallel on the left side of the linkage worm gear 55, and the linkage worm gear 55 is clamped on the upper and lower sides by the first worm 52 and the second worm 54, resulting in a more compact overall structure and stable meshing.

In addition, the telescopic and rotatable massager further includes a battery 92, the battery 92 is used to supply power to the overall circuit of the massager, and the battery 92 is a flat cuboid; the assembling portion 3 is provided with a mounting side portion 31 at a left end thereof near a front side, and one end of the linkage swing rod 56 is hinged to a front left end of the mounting side portion 31; the battery 92 is located behind the mounting side portion 31; and a projection of the battery 92 along the sliding direction of the massage stick 2 at least partially falls on the assembling portion 3. This results in a more compact overall structure.

Specifically, the vibration power device 6 in the present embodiment is a vibrating motor.

Specifically, the gripping portion 1 includes an outer housing 11 and an inner housing 12; where a first inner cavity 113 is provided in the outer housing 11, the outer housing 11 includes a first cylinder portion 111 and a second cylinder portion 112 that can be detached in the left-right direction, the first cylinder portion 111 and the second cylinder portion 112 are inserted into each other in the left-right direction for fit to form the outer housing 11, and the first cylinder portion 111 and the second cylinder portion 112 are detached left and right to open the first inner cavity 113. The inner housing 12 is disposed in the first inner cavity 113; a second inner cavity 123 is provided in the inner housing 12, the inner housing 12 includes a first housing portion 121 and a second housing portion 122 that can be detached in the front-back direction, the first housing portion 121 and the second housing portion 122 are inserted into each other in the front-back direction for fit to form the inner housing 12, and the first housing portion 121 and the second housing portion 122 are detached front and back to open the second inner cavity 123; and the telescopic power device 5 is disposed in the second inner cavity 123. In addition, the first housing portion 121 and the second housing portion 122 are fixedly mounted with a plurality of bolts in the front-back direction, and then the first cylinder portion 111 and the second cylinder portion 112 are combined to wrap the inner housing 12, and the first fixing bolt 13 is provided between the first cylinder portion 111 and the first housing portion 121, and a second fixing bolt 14 is provided between the second cylinder portion 112 and the second housing portion 122, and axial directions of the first fixing bolt 13 and the second fixing bolt 14 are both along the left-right direction, so that the overall structure is more stable after the mounting is completed.

Furthermore, the gripping portion 1 further includes a guide sleeve 15, the guide sleeve 15 is cylindrical in shape, and an outer periphery of the guide sleeve 15 is clamped by the first housing portion 121 and the second housing portion 122 for fixed mounting, a bar-shaped slot 151 is provided on an inner periphery of the guide sleeve 15, and correspondingly a bar-shaped snap-in protrusion 32 is provided on an outer periphery of the assembling portion 3, so that the bar-shaped slot 151 and the bar-shaped snap-in protrusion 32 are guided and snap-fitted to achieve sliding fit between the assembling portion 3 and the gripping portion 1.

Furthermore, a corrugated sealing sleeve 17 is provided between the massage stick 2 and the gripping portion 1, the corrugated sealing sleeve 17 is used to seal an intersection of the assembling portion 3 and the gripping portion 1, and the corrugated sealing sleeve 17 is adapted to deform when the massage stick 2 slides back and forth.

Specifically, an elastic sleeve 21 molded from a silicone material is wrapped around the outer periphery of the massage stick 2, a right end of the corrugated sealing sleeve 17 and the elastic sleeve 21 are integrally molded, and the gripping portion 1 is detachably provided with an annular second clamping end cover 18 at the right end thereof by means of bolts, and the corrugated sealing sleeve 17 is provided with an annular second clamping sealing portion 172 at a left end thereof, and both sides of the second clamping sealing portion 172 are clamped by the gripping portion 1 and the second clamping end cover 18 for mounting.

In order to improve mounting stability at the second clamping sealing portion 172, an annular groove is further provided radially inward on the right side of the second clamping sealing portion 172, and an annular convex portion is correspondingly provided on the second clamping end cover 18, so that the mounting stability is improved through snap connection between the annular groove and the annular convex portion.

Therefore, 1. the gap between the assembling portion 3 and the gripping portion 1 can be sealed under the action of the corrugated sealing sleeve 17 to prevent dust and water from entering the gripping portion 1 and play a protective role, and because the corrugated sealing sleeve 17 can be deformed to adapt to the telescopic motion of the massage stick 2 relative to the gripping portion 1; 2. the elastic sleeve 21 is disposed to enable the outer periphery of the massage stick 2 to be elastic, thus improving comfort; and 3. the elastic sleeve 21 and one end of the corrugated sealing sleeve 17 are integrally molded, which reduces the number of parts and further simplifies the overall structure.

In addition, the gripping portion 1 is provided with an elastic ring 19 at one end thereof facing the massage stick 2, and the massage stick 2 is positioned within an inner periphery of the elastic ring 19. This allows the gripping portion 1 to be placed against the human body, thus enhancing comfort through contact between the elastic ring 19 and the human body.

Preferably, the elastic ring 19 includes a mounting portion 191 that is snap-mounted to the gripping portion 1. Specifically, the annular convex portion is disposed on a left side of an inner periphery of the elastic ring 19, and the annular groove is correspondingly disposed on an outer periphery of the second clamping end cover 18, thus improving mounting stability through snap connection between the annular groove and the annular convex portion.

Preferably, the elastic ring 19 is provided with an impact deformation portion 192 extending inward toward the right along the radial direction on a right side thereof, so that when the gripping portion 1 is brought to quickly approach the human body and come into contact with the human body, buffering is provided by the more easily deformable impact deformation portion 192, thus reducing the impact force on the human body and making the use more comfortable.

Here, the present embodiment further includes a first electrical connection assembly 81, the first electrical connection assembly 81 includes a first component 811 and a second component 812, the first component 811 and the second component 812 are fixedly disposed relative to the massage stick 2 and the massage head 4 respectively, and the first component 811 and the second component 812 are disposed in a contact manner to achieve a conducting state of the first component 811 and the second component 812 during rotation of the massage head 4 relative to the massage stick 2.

Therefore, the first component 811 and the second component 812 conduct the circuits in the massage stick 2 and the circuits in the massage head 4, so that the battery 92 in the gripping portion 1 can supply power to the vibration power device 6 in the massage head 4 through the circuits.

In other embodiments, a power supply structure such as a battery 92 may be provided in the massage head 4 to supply power to the vibration power device 6, and the vibration power device 6 may be controlled by wireless means such as Bluetooth.

Specifically, the rotating power device 7 includes a third motor 71 and a connector 72, the third motor 71 is assembled in the massage stick 2 by bolts or the like, and an output shaft of the third motor 71 extends to the right, the connector 72 is fixedly mounted on a left end of the massage head 4 by bolts or the like, and the connector 72 extends to the left in a length direction thereof and extends into the massage stick 2, and the output shaft of the third motor 71 is inserted into the connector 72 and fixed by latches or the like, so that operation of the third motor 71 can be driven by the rotation of the massage head 4 through the connector 72.

Here, the connector 72 is provided with two sealing rings on an outer periphery thereof, one of the sealing rings is fitted with a peripheral wall of the massage stick 2, and the other sealing ring is fitted with a peripheral wall of the massage head 4 for sealing, thus providing protection for the third motor 71 and the vibration power device 6.

Here, the present embodiment provides two structures for the first electrical connection assembly 81.

The first type of structure of the first electrical connection assembly 81 is as follows: the first component 811 and the second component 812 are in the shape of a disk in the axial direction along the left-right direction, the first component 811 and the second component 812 are disposed opposite to each other in the left-right direction, the first component 811 is fixedly mounted on the massage stick 2 through snap-connection or the like, and the second component 812 is fixedly mounted on a left end of the connector 72 by bolts or the like, where the first component 811 is provided with a first conduction ring 8111 and a second conduction ring 8112 on a right side thereof, and the first conduction ring 8111 and the second conduction ring 8112 are circular with a certain width in the radial direction, the first conduction ring 8111 and the second conduction ring 8112 are disposed coaxially, and the first conduction ring 8111 is positioned within an inner periphery of the second conduction ring 8112 to be arranged in the radial direction; and correspondingly, the second component 812 is provided with a first guide conduction portion 8121 elastically abutted against the first conduction ring 8111 and a second conduction portion 8122 elastically abutted against the second conduction ring 8112, and both the first conduction portion 8121 and the second conduction portion 8122 are formed by bending elastic sheets.

Therefore, the elastic conduction between the first conduction portion 8121 and the first conduction ring 8111 and the elastic conduction between the second conduction portion 8122 and the second conduction ring 8112 ensure stable conduction of the circuits during relative rotation of the first component 811 and the second component 812.

Preferably, two conduction seats 8129 are centrally symmetrically provided on the second component 812, two first conduction portions 8121 and two second conduction portions 8122 are provided, and one of the first conduction portions 8121 and one of the second conduction portions 8122 are respectively disposed on each of the conduction seats 8129. This allows the first conduction portion 8121 and the second conduction portion 8122 on the two conduction seats 8129 to be elastically abutted against the first conduction ring 8111 and the second conduction ring 8112 respectively to improve uniformity of the circumferential force.

In other embodiments, a different number of the first conduction portions 8121 and the second conduction portions 8122 may be provided.

The second type of structure of the first electrical connection component 81 is as follows: the first component 811 includes a third conduction ring 8113 and a fourth conduction ring 8114 arranged along the left-right direction; the third conduction ring 8113 and the fourth conduction ring 8114 are circular with a certain width in the axial direction, the third conduction ring 8113 and the fourth conduction ring 8114 are both sleeved on the outer periphery of the connector 72 and fixed to the connector 72 by adhesive bonding, bolts or the like; correspondingly, the second component 812 includes a third conduction portion 8123 and a fourth conduction portion 8124, the third conduction portion 8123 and the fourth conduction portion 8124 are fixedly configured on the massage stick 2 by snap connection or the like, the third conduction portion 8123 is elastically abutted against an outer peripheral surface of the third conduction ring 8113, and the fourth conduction portion 8124 is elastically abutted against an outer peripheral surface of the fourth conduction ring 8114; and both the third conduction portion 8123 and the fourth conduction portion 8124 are formed by bending elastic sheets.

Therefore, the elastic conduction between the third conduction portion 8123 and the third conduction ring 8113, and the elastic conduction between the fourth conduction portion 8124 and the fourth conduction ring 8114 ensure stable conduction of the circuits during relative rotation of the first component 811 and the second component 812.

In other embodiments, the third conduction ring 8113 and the fourth conduction ring 8114 may be fixedly mounted on the massage stick 2, and correspondingly, the third conduction portion 8123 and the fourth conduction portion 8124 may be fixedly mounted on the connector 72.

In the present embodiment, wires are used to guide-connect circuit structures such as circuit boards and the battery 92, the assembling portion 3 is provided with a first wiring channel 33 that runs through to the right, and the mounting side portion 31 is provided at a front upper position thereof with a first wiring notch 311 communicating with the first wiring channel 33, so that the wires conduct the circuits in the gripping portion 1 and the massage stick 2 through the first wiring notch 311 and the first wiring channel 33, the connector 72 is provided at a middle right position thereof with a second wiring channel 721, the second wiring channel 721 has an opening at a right end thereof, and the second wiring channel 721 has an open at a lower end thereof, while the connector 72 is provided at a lower left end position thereof with a second wiring notch 722, so that the wires led out of the second component 812 first pass through the second wiring notch 722, then enter the second wiring channel 721 through the opening at the left end of the second wiring channel 721, and finally enter the massage head 4 through the opening at the right end of the second wiring notch 722 for conduction and power supply.

Furthermore, in the present embodiment, a heating plate is provided in the massage stick 2 and/or the massage head 4, so that the massage stick 2 and/or the massage head 4 can be heated by energizing the heating plate to improve the comfort of massage.

### Embodiment 2

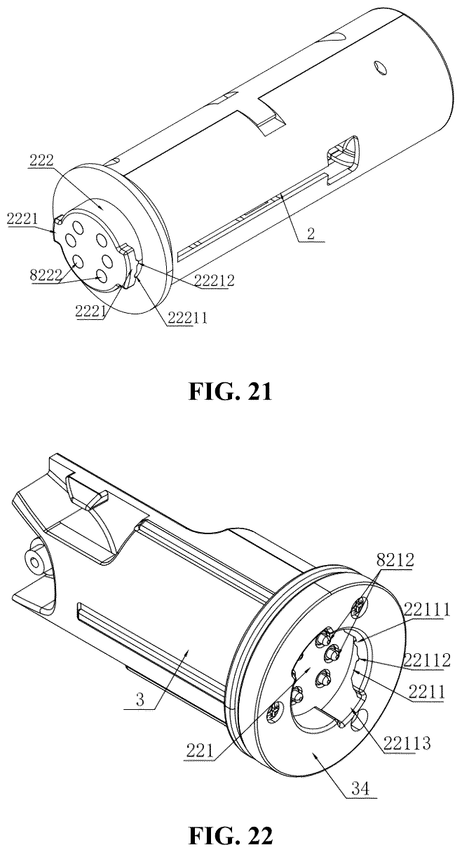

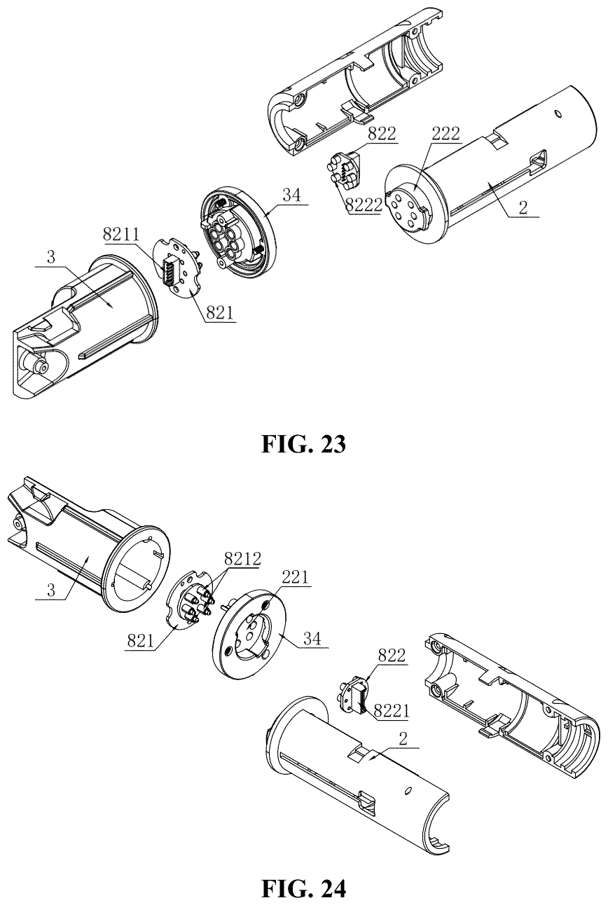

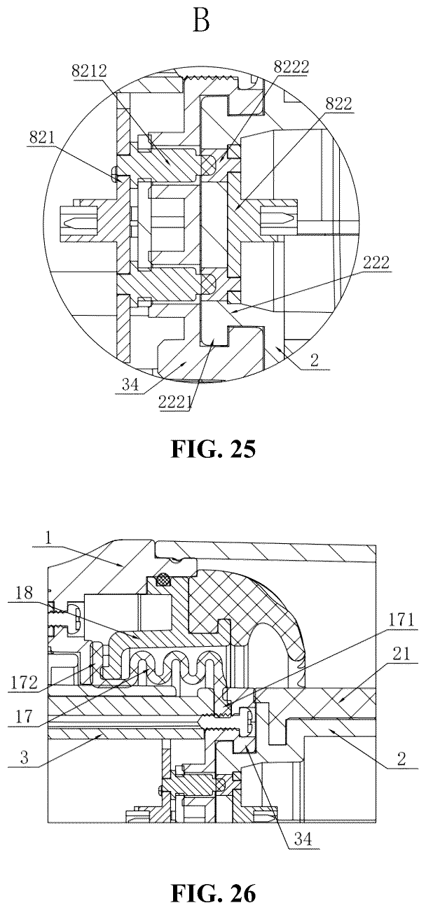

As shown in FIGS. 19-26, the present embodiment discloses a telescopic and rotatable massager which has a main structure the same as Embodiment 1, except that the massage stick 2 and the assembling portion 3 are detachably disposed.

Therefore, by preparing massage sticks 2 with different functions, the massage stick 2 can be replaced according to different usage requirements to improve adaptability.

Specifically, a detachable structure 22 is provided between the massage stick 2 and the assembling portion 3, and the detachable structure 22 includes a rotating slot 221 and a rotating insertion portion 222, where the rotating slot 221 is disposed at a right end of the assembling portion 3 and is in a cylindrical shape extending from the left to the right, and the rotating insertion portion 222 is integrally molded at the left end of the massage stick 2 and is in a cylindrical shape extending from the left to the right. In addition, the rotating slot 221 is provided with a plurality of anti-detachment tracks 2211 extending in a circumferential direction at a left end of an outer periphery thereof, arc-shaped ends of the anti-detachment tracks 2211 penetrates to the right end of the assembling portion 3 toward the right and forms an insertion opening 22113. Correspondingly, an anti-detachment slider 2221 is provided on a left side of an outer periphery of the rotating insertion portion 222. Therefore, when the anti-detachment slider 2221 and the insertion opening 22113 are aligned, the massage stick 2 and the assembling portion 3 are close to each other, so that the rotating insertion portion 222 is inserted into the rotating slot 221, and the anti-detachment slider 2221 is inserted into the anti-detachment track 2211, and then the massage stick 2 and the assembling portion 3 rotate relative to each other, so that the anti-detachment slider 2221 slides in the anti-detachment track 2211 to misalign with the insertion opening 22113 to complete mounting of the massage stick 2 and the assembling portion 3; and the massage stick 2 can be disassembled by reverse operation.

In addition, a first snap-in protrusion 22111 and a first snap-in recess 22112 are provided in each of the anti-detachment tracks 2211, and a second snap-in recess 22211 for snap-fitting the first snap-in protrusion 22111 and a second snap-in protrusion 22212 for snap-fitting the first snap-in recess 22112 are provided on the anti-detachment slider 2221, where the first snap-in protrusion 22111, the first snap-in recess 22112, the second snap-in protrusion 22212, and the second snap-in recess 22211 are all semi-cylindrical to enable the anti-detachment slider 2221 to be inserted into each of the anti-detachment tracks 2211 and rotated to result in snap fit between the first snap-in protrusion 22111 and the second snap-in recess 22211 and snap fit between the first snap-in recess 22112 and the second snap-in protrusion 22212. With the anti-detachment slider 2221 and the insertion opening 22113 in a misaligned state, rotation of the anti-detachment slider 2221 in the anti-detachment track 2211 is restricted to improve assembly stability.

Here, a second electrical connection assembly 82 is provided between the massage stick 2 and the assembling portion 3. Specifically, the second electrical connection assembly 82 includes a first circuit board 821 and a second circuit board 822, the first circuit board 821 is fixedly mounted on the assembling portion 3 and is located on a left side of the rotating slot 221, in addition, the first circuit board 821 is provided with a first wiring socket 8211 on a left side thereof, and the first circuit board 821 is provided with a plurality of first electrical connection portions 8212 arranged at intervals along a circumferential direction at a right side thereof, and each of the first electrical connection portions 8212 penetrates the bottom of the rotating slot 221 toward the right, and partially extends into the rotating slot 221. Correspondingly, the second circuit board 822 is fixedly mounted on the massage stick 2 and is located in the rotating insertion portion 222. In addition, the second circuit board 822 is provided with a second wiring socket 8221 on a right side thereof, and the second circuit board 822 is provided with a plurality of second electrical connection portions 8222 arranged at intervals along the circumferential direction on a left side thereof, and each of the second electrical connection portions 8222 penetrates toward the left to the top of the rotating insertion portion 222.

Therefore, the rotating insertion portion 222 is inserted into the rotating slot 221 and rotates in the rotating slot 221 to bring the first electrical connection portions 8212 and the second electrical connection portions 8222 into contact and conduction.

Preferably, the first electrical connection portion 8212 adopts an elastic contact head to ensure more stable contact between the first electrical connection portions 8212 and the second electrical connection portions 8222.

In addition, since the assembling portion 3 and the massage stick 2 are detachable so that the corrugated sealing sleeve 17 and the elastic sleeve 21 are separated, in order to mount the corrugated sealing sleeve 17 on the assembling portion 3, the assembling portion 3 is detachably provided with a first clamping end cover 34 by bolts at one end thereof facing the right, and the rotating slot 221 is disposed on the first clamping end cover 34, so that the massage stick 2 is detachably assembled to the first clamping end cover 34; and the corrugated sealing sleeve 17 is provided with an annular first clamping sealing portion 171 at a right side thereof, and both sides of the first clamping sealing portion 171 are clamped by the assembling portion 3 and the first clamping end cover 34 for mounting.

Therefore, the corrugated sealing sleeve 17 seals the assembling portion 3 and the gripping portion 1, ensuring effective sealing regardless of whether the massage stick 2 is assembled or disassembled.

The previous description of the disclosed embodiments is provided to enable any person skilled in the art to make or use the present invention. Various modifications to these embodiments will be readily apparent to those skilled in the art, and the generic principles defined herein may be implemented in other embodiments without departing from the spirit or scope of the present invention. Thus, the present invention is not intended to be limited to the embodiments shown herein but is to be accorded the widest scope consistent with the principles and novel features disclosed herein.

What is claimed is:

1. A telescopic and rotatable massager, comprising:
a gripping portion;
a massage stick, wherein the massage stick is provided with an assembling portion in sliding fit with the gripping portion at a first end thereof, and the massage stick is slidably disposed relative to the gripping portion along a length direction thereof, the massage stick is provided with a rotatable massage head at a second end opposite to the first end, and a rotation axis of the massage head is provided parallel to a sliding direction of the massage stick;
a telescopic power device for driving the massage stick to slide back and forth, wherein the telescopic power device is disposed in the gripping portion; and
a rotating power device for driving the massage head to rotate, wherein the rotating power device is disposed in the massage stick.

2. The telescopic and rotatable massager according to claim 1, wherein the telescopic power device comprises a first motor, a first worm, a linkage worm gear and a linkage swing rod, the first worm is connected with an output shaft of the first motor, the linkage worm gear is rotatably disposed relative to the gripping portion, the first worm is meshed with the linkage worm gear, and the linkage swing rod is rotatably disposed relative to the linkage worm gear and the assembling portion respectively; and
a rotation axis of the linkage worm gear relative to the gripping portion is k1, a rotation axis of the linkage swing rod relative to the linkage worm gear is k2, a rotation axis of the linkage swing rod relative to the assembling portion is k3, k1, k2 and k3 are disposed non-collinear and parallel, and k1 is perpendicular to the sliding direction of the massage stick.

3. The telescopic and rotatable massager according to claim 2, wherein the telescopic power device further comprises a second motor and a second worm, the second worm is connected with an output shaft of the second motor, and the second worm is meshed with the linkage worm gear.

4. The telescopic and rotatable massager according to claim 3, wherein the first motor and the second motor are located on a side of the linkage worm gear away from the massage stick; and/or
the first worm and the second worm are located on opposite sides of the linkage worm gear; and/or
an axial direction of the first worm and an axial direction of the second worm are both disposed along the sliding direction of the massage stick.

5. The telescopic and rotatable massager according to claim 2, further comprising a battery, wherein the assembling portion is provided with a mounting side portion at one end thereof away from the massage stick, the linkage swing rod is hinged to the mounting side portion, the battery is located on one side of the mounting side portion along the k1 direction, and a projection of the battery along the sliding direction of the massage stick at least partially falls on the assembling portion.

6. The telescopic and rotatable massager according to claim 1, wherein a corrugated sealing sleeve is provided between the massage stick and the gripping portion or between the assembling portion and the gripping portion, the corrugated sealing sleeve seals an intersection of the assembling portion and the gripping portion, and the corrugated sealing sleeve is adapted to deform when the massage stick slides back and forth.

7. The telescopic and rotatable massager according to claim 6, wherein an elastic sleeve is wrapped around an outer periphery of the massage bar, and a first end of the corrugated sealing sleeve and the elastic sleeve are integrally molded; and
the assembling portion is detachably provided with a first clamping end cover at one end thereof facing the massage stick, the first clamping end cover is connected with the massage stick, the corrugated sealing sleeve is provided with a first clamping sealing portion at the first end, and both sides of the first clamping sealing portion are clamped by the assembling portion and the first clamping end cover for mounting.

8. The telescopic and rotatable massager according to claim 7, wherein the gripping portion is detachably provided with a second clamping end cover at one end thereof facing the massage stick, the corrugated sealing sleeve is provided with a second clamping sealing portion at a second end opposite to the first end, and both sides of the second clamping sealing portion are clamped by the gripping portion and the second clamping end cover for mounting.

9. The telescopic and rotatable massager according to claim 1, wherein the gripping portion is provided with an elastic ring at the end facing the massage stick, and the massage stick is positioned within an inner periphery of the elastic ring.

10. The telescopic and rotatable massager according to claim 9, wherein the elastic ring comprises a mounting portion snap-mounted on the gripping portion; and/or
the elastic ring is provided with an impact deformation portion away from the gripping portion along an axial direction and extending inward along a radial direction at one end thereof facing the massage stick.

11. The telescopic and rotatable massager according to claim 1, further comprising a vibration power device for driving the massage head to vibrate, wherein the vibration power device is disposed in the massage head.

12. The telescopic and rotatable massager according to claim 1, further comprising a first electrical connection assembly, wherein the first electrical connection assembly comprises a first component and a second component, the first component and the second component are fixedly disposed relative to the massage stick and the massage head respectively, and the first component and the second component are disposed in a contact manner to achieve a conducting state of the first component and the second component during rotation of the massage head relative to the massage stick.

13. The telescopic and rotatable massager according to claim 12, wherein the first component and the second component are disposed opposite along the sliding direction of the massage stick, the first component is provided with a first conduction ring and a second conduction ring on a side thereof facing the second component, and the first conduction ring and the second conduction ring are arranged in a radial direction, and the second component is provided with a first conduction portion elastically abutted against the first conduction ring and a second conduction portion elastically abutted against the second conduction ring.

14. The telescopic and rotatable massager according to claim 13, wherein a plurality of the first conduction portions are provided, each of the first conduction portions is arranged at intervals along a circumferential direction, and a plurality of the second conduction portions are provided, each of the second conduction portions is arranged at intervals along the circumferential direction; and/or
two conduction seats are centrally symmetrically provided on the second component, two first conduction portions and two second conduction portions are provided, and one of the first conduction portions and one of the second conduction portions are respectively disposed on each of the conduction seats.

15. The telescopic and rotatable massager according to claim 12, wherein the first component comprises a third conduction ring and a fourth conduction ring arranged in the sliding direction of the massage stick, the second component comprises a third conduction portion and a fourth conduction portion, the third conduction portion is elastically abutted against an outer peripheral surface or an inner peripheral surface of the third conduction ring, and the fourth conduction portion is elastically abutted against an outer peripheral surface or an inner peripheral surface of the fourth conduction ring.

16. The telescopic and rotatable massager according to claim 15, wherein the rotating power device comprises a third motor and a connector, the third motor is assembled in the massage stick and an output shaft of the third motor is disposed toward the massage head, and the connector connects the output shaft of the third motor with the massage head; and
the third conduction ring and the fourth conduction ring are annularly disposed on an outer periphery of the connector and are fixedly mounted on the connector, the third conduction portion is located on an outer periphery of the third conduction ring, the third conduction portion is elastically abutted against the outer peripheral surface of the third conduction ring, the fourth conduction portion is located on an outer periphery of the fourth conduction ring, and the fourth conduction portion is elastically abutted against the outer peripheral surface of the fourth conduction ring, and the third conduction portion and the fourth conduction portion are fixedly mounted on the massage stick.

17. The telescopic and rotatable massager according to claim 1, wherein the massage stick and the assembling portion are detachably disposed;
a detachable structure is provided between the massage stick and the assembling portion, the detachable structure comprises a rotating slot and a rotating insertion portion respectively provided on the massage stick and the assembling portion, anti-detachment tracks extending along a circumferential direction are provided on an outer periphery of the rotating slot, an insertion opening is provided on the anti-detachment track, and an anti-detachment slider is provided on an outer periphery of the rotating insertion portion; and
when the anti-detachment slider and the insertion opening are aligned, the massage stick and the assembling portion are close to each other so that the rotating insertion portion is inserted into the rotating slot and the anti-detachment slider is inserted into the anti-detachment track, and then the massage stick and the assembling portion rotate relative to each other so that the anti-detachment slider slides in the anti-detachment track and becomes misaligned with the insertion opening.

18. The telescopic and rotatable massager according to claim 17, wherein the anti-detachment track and the anti-detachment slider are combined into multiple groups and arranged at intervals in the circumferential direction.

19. The telescopic and rotatable massager according to claim 17, wherein the anti-detachment track is provided with a first snap-in protrusion and/or a first snap-in recess therein, the anti-detachment slider is provided with a second snap-in recess for snap-fitting the first snap-in protrusion and/or a second snap-in protrusion for snap-fitting the first snap-in recess, and when the first snap-in protrusion and the second snap-in recess are fitted to each other and/or the first snap-in recess and the second snap-in protrusion are fitted to each other, the anti-detachment slider and the insertion opening are in a misaligned state to restrict rotation of the anti-detachment slider in the anti-detachment track.

20. The telescopic and rotatable massager according to claim 17, wherein a second electrical connection assembly is provided between the massage stick and the assembling portion, the second electrical connection assembly comprises a first circuit board and a second circuit board respectively provided in the massage stick and the assembling portion, a plurality of the first electrical connection portions are provided on the first circuit board, each of the first electrical connection portions is arranged at the bottom of the rotating slot along the circumferential direction, a plurality of the second electrical connection portions are provided on the second circuit board, each of the second electrical connection portions is arranged at the top of the rotating insertion portion along the circumferential direction, and the rotating insertion portion is inserted into the rotating slot and rotates in the rotating slot to make the first electrical connection portion and second electrical connection portion contact and conduct.
